(19) United States
(12) Patent Application Publication
(10) Pub. No.: US 2007/0016886 A1
(43) Pub. Date: Jan. 18, 2007

(54) Business management and procedures involving a smart pipe of tiered innovation management teams

(76) Inventor: Donald O'Neill, Montgomery Village, MD (US)

Correspondence Address: DONALD O'NEILL, 9305 KOBE WAY, MONTGOMERY VILLAGE, MD, 20886, US

(21) Appl. No.: 11/182,120

(22) Filed: Jul. 15, 2005

(51) Int. Cl. G06F 9/44

(52) U.S. Cl. 717/101

(57) ABSTRACT

The invention specifies a process for carrying out innovation management whereby the roles of multi-disciplined stakeholders are distinguished in such a way as to facilitate the assignment of high value knowledge-based service innovation onshore and to permit the highest skill work to move to the lowest cost of market-driven performance whether onshore or offshore.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention relates to the field of management of a business and economical enterprise operation that is directed toward harvesting ideas as intellectual property from knowledge workers on projects, selecting the most promising ideas and refining them into well framed statements of value, and impacting the business strategy and development with the best ideas for improving the competitiveness and profitability of the business and the value of the enterprise. The invention provides business management and procedures for the practice of innovation management suitable for a global sourcing environment.

Innovation enables an enterprise to elevate its offerings in the software stack. Team Innovation Management (TIM) is organized to encourage innovation within the U.S. software industry and to advance the competitive development of the enterprise by renovating functional tasks and activities and accelerating the innovation management capability and capacity needed to substantially increase innovation in both the production and use of systems and software. It is specifically focused on the systems engineering and software engineering roles and capabilities needed to systematically collaborate in the cross discipline intersection between producer and consumer.

### BRIEF SUMMARY OF THE INVENTION

Primarily, the smart pipe, tiered process will synthesize the interconnected layers or contexts formed by innovators who generate ideas, brokers who manage ideas and idea development, and buyers who use ideas for the benefit of the enterprise. The three tiers operate to identify innovative ideas and specify their value in multiple dimensions in a statement of innovation value, to judge and select the most promising value statements and to identify refinements intended to increase their benefit, and to incorporate the best ideas in the business strategy and ongoing development in order to improve the competitiveness and profitability of the business and the value of the enterprise. The three tiers of the smart pipe are synchronized through steering guidance from buyers to brokers and from brokers to innovators.

The three processes span onshore and offshore operations. The innovators in tier 1 include both global enterprise personnel and outsourced personnel who might be all onshore, all offshore, or some onshore and some onshore. The committee of brokers in tier 2 includes global enterprise personnel who are expected to be onshore. The buyers in the marketplace in tier 3 include global enterprise personnel who are expected to be onshore.

It is an object of the invention to provide a timely and continuous flow of innovative ideas from knowledge workers on projects and to systematically select the most promising ideas for refinement and use as enterprise intellectual property.

Another object is to increase U.S. innovation in both the production and use of software products and systems by aligning global software participants and functional tasks according to an innovation-driven value hierarchy, thereby, retaining high value knowledge-based service innovation onshore while pushing the highest skill work to the lowest cost of performance whether onshore or offshore.

Another object is to minimize the risks and maintain the benefits of an economic globally based enterprise that deals with software producers in offshore nations that would otherwise be barred by adverse risks associated with such global enterprises in particular the management and recapture of intellectual property created during an engagement.

Other objects of the invention will be apparent to those skilled in the art once the invention is shown and described.

### BRIEF DESCRIPTION OF THE SEVERAL VIEWS OF THE DRAWING

FIG. 1 the smart pipe process flow shown as a state machine;

FIG. 2 the smart pipe process shown as an ETVX diagram;

FIG. 3 Tier 1 innovators at the intersection process shown as an ETVX diagram;

FIG. 4 the multi-discipline intersection of innovation;

FIG. 5 Tier 2 committee of brokers process shown as an ETVX diagram;

FIG. 6 Tier 3 buyers in the marketplace process shown as an ETVX diagram.

### DETAILED DESCRIPTION OF THE INVENTION

Background

The Center for National Software Studies (CNSS) has recently released the “Software 2015: A National Software Strategy to Ensure Security and Competitiveness”, a report from the Second National Software Summit [1]. The Software 2015 Report identifies four programs and eleven initiatives to carry out the national software strategy. One of these programs focuses on encouraging innovation. As the Executive Vice President for the CNSS, I have directed the global software competitiveness studies and authored the section of the Software 2015 Report on encouraging innovation. Team Innovation Management (TIM) is organized to transform research into practice and is being conducted to renovate and accelerate innovation management capability and capacity in the production and use of systems and software.

Macroeconomic Positioning

Michael Porter of Harvard University has identified the macroeconomic stages that drive national competitive development including cheap labor, investment in infrastructure, innovation, and economic advantage [2]. The U.S. is now transitioning from the investment driven stage where the infrastructure is organized to improve productivity and quality to the knowledge-based, innovation driven stage where software and information technology intersect with application domains in every industry sector to produce novel and useful results that extend the state of the art [3]. In fact the creative sector of the U.S. economy accounts for 47% of the wealth generated with 30% of the workforce [4].

Innovation enables an enterprise to elevate its offerings in the software stack. To ignore innovation is to risk falling into commodity status . . . and offshoring. Innovation in the industrial age was achieved through individual genius; in the knowledge age, from collaborative activity.

The U.S. has been pushed out of the cheap labor stage and can't seem to complete the infrastructure stage, but necessity has forced upon us the dual challenges of innovation and offshore outsourcing. The outcomes envisioned in dealing with these dual challenges include increasing U.S. innovation in both the production and use of software products and systems, aligning global software participants and functional tasks according to an innovation-driven, value hierarchy, and retaining high value, knowledge-based service innovation onshore while pushing the highest skill work to the lowest cost of performance whether onshore or offshore [1].

R&D and Innovation

The first step in seeding the future and dealing with the challenge of innovation is to distinguish R&D and Innovation. The government view and the industry view present us with a dual focus.

Government sponsored R&D is aimed at a limited number of large innovations. This Innovation in the Large results in public goods not appropriable by a single enterprise and open to all both onshore and offshore. The artifacts of Government R&D are roadmaps and agendas that facilitate dissemination and foster collaboration.

The business enterprise focuses on an uncountably large number of small innovations. This Innovation in the Small yields private goods fully appropriable unless the enterprise chooses to make them open, an emerging business practice. The artifacts of enterprise innovation are the distinguishing products that deliver business success and boost competitiveness and the patents that insure future success. Here inventors are the point of the spear in the struggle for global competitiveness. The Team Innovation Management (TIM) research is seeking a systematic approach to achieving Innovation in the Small.

Business Context

In progressing towards maturity in accordance with the Carnegie Mellon University Software Engineering Institute's Capability Maturity Model Integrated (CMMI), many organizations breeze past the even numbered process maturity levels (2, 4) with ease only to struggle with the odd levels (3, 5) [5]. This is especially true of level 5 whose very foundation is less well defined and understood. The Organizational Innovation and Deployment process area is often overlooked, viewed more as an obstacle to a successful assessment and less as a value producing mechanism. The bigger concern here is that the CMMI Organizational Innovation and Deployment process area is too narrowly and inwardly focused on process innovation and fails to capture product innovation. The Air Force also overlooked innovation in listing its minimum software focus areas in its memo (04A-003) on “Revitalizing the Software Aspects of System Engineering” [6].

While achieving innovation is sporadic, management insists on something more systematic. Team Innovation Management (TIM) bridges the gap between the realities of uncertainty and experimentation associated with creativity and invention and the more focused goals and objectives environment of the enterprise and its managers. IBM's “Global CEO Study 2004” reported that today's CEO's are intent on increasing revenue through new and differentiated products and services and on containing cost through strategic offshore outsource partnering. In the Balanced Scorecard, the choices are operational excellence, customer intimacy, and product innovation [7]. Team Innovation Management (TIM) addresses product innovation.

Becoming Innovative

Essential behaviors found in an innovative work environment include listening to stakeholders, valuing diversity of thought, giving way to superior knowledge, brainstorming ideas where judgment is deferred, encouraging a high volume of ideas, and breaking old habits that limit thinking.

Value Point

In pursuing innovation it pays to focus on value. In software these are value points. “Software: the infrastructure within the critical infrastructure” [1] disciplines the Team Innovation Management (TIM) focus on software usage where the value points of critical industries are identified. A value point is a computer program or software system within an enterprise product line that is strategically essential to the competitiveness of the enterprise. Once identified, value points are tagged as strategic assets subject to the rigors of the enterprise strategic planning process. This ensures that allocated resources are committed to achieve the best industry practice in their project management, product engineering, and process management.

Research Direction

Team Innovation Management (TIM) research is committed to identifying, applying, and verifying the practice, knowledge, skills, and behaviors needed to substantially increase innovation in both the production and use of systems and software. It is specifically focused on the systems engineering and software engineering roles and capabilities needed to systematically collaborate in the cross discipline intersection between producer and consumer.

The goals of Team Innovation Management (TIM) are to:
1. Encourage innovation within the U.S. software industry in accordance with “Software 2015: A National Software Strategy to Ensure U.S. Security and Competitiveness,” report of the Second National Software Summit. http://www.CNsoftware.org [1]
2. Advance the competitive development of the enterprise by renovating functional tasks and activities and accelerating the innovation management capability and capacity needed to substantially increase innovation in both the production and use of systems and software.
3. Provide systems engineers and software engineers with the essential knowledge, skills, behaviors, and motivation needed to substantially improve team innovation management in the enterprise and on the project.
   The Paradigm Shift

Past is not prologue. Achieving innovation demands an important paradigm shift. While the pursuit of innovation may be systematic, achieving innovation is more chaotic. In some ways innovation management resembles quality process improvement, but the paradigm is essentially different. While the infrastructure-based quality process demands conformance, standards compliance, and risk adversity with the hope for perfection, the innovation management process demands creativity, experimentation, and risk taking with the hope for success but the possibility of failure. Consequently, the enterprise faces a competency destroying change management challenge for both staff and management.

The enterprise beginning the transition from an infrastructure-based quality process to an innovation management operation may tend to depend too much on getting lucky and not enough on being good.
1. In getting lucky, success is measured in terms of return on technology where gains too easily labeled as innovative are commoditized at the outset, and directional changes originate from the producer that tend to promote efficiency and better-cheaper-faster, all of which draw upon existing enterprise staff skills and old visions from the infrastructure stage.
2. In being good, success is measured in terms of return on innovation where truly innovative gains are more strategic, and intersectional changes originate in the cross discipline collaboration and culture clash between producer and consumer where changes are deep seated and transformational, all of which require the renovation of enterprise staff skills and new visions.
   The Intersection

The intersection is an energizing model and the place where innovation occurs. Innovative ideas exist in the minds of practitioners; they simply must be harvested. Innovation lies at the intersection of invention and insight dependent on ideas, collaboration, and expertise [8]. At the intersection there are many ideas and many combinations, and there are many forces including culture, science, and high performance computing.

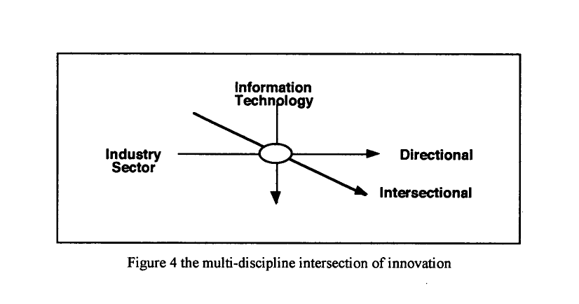

The multi-discipline intersection of innovation is modeled as shown in FIG. 4. Software engineers and information technology specialists enter the intersection from the top. Systems engineers and industry specialists enter the intersection from the left. Once a systems engineer and a software engineer pair step into the intersection there is a clash of disciplines and culture. The initial reaction of participants may be to recoil and repel the onslaught of new ideas and concepts and retreat into the comfort zone of ones profession with its protective myths and biases . . . and old habits.

Once at the intersection, it is the role and responsibility of the systems engineer and the software engineer to generate as many ideas as possible.
1. Some ideas will be simply directional, rules-based work force reducing efficiencies [9]. Directional ideas spawn new features and capabilities, are often customer driven, and can be implemented by planned and predictable steps. These new features may extend the dwell time of the product line within the niche.
2. Others will be intersectional, process pattern transformations [9] that involve radically new directions driven by the cross discipline clash with new directions not based on detailed knowledge and ideas originated from people least expected. These new directions may open new niches.

Applying one of the essential behaviors, there is no substitute for superior knowledge. The systems engineer brings an understanding of the state of technology and ongoing collaborative research as well as application domain patterns, system requirements, customer needs, and sustaining operations. The software engineer brings an understanding of available Commercial Off the Shelf (COTS) solutions and open source resources as well as the software engineering practices that foster the structure and modularity needed for trustworthiness and usability and the computer science foundations that enable numerical analysis needed for performance and reliability.

The systems engineer and software engineer attempt to discover the deep needs of the project and to draw out the customer desires and operational considerations that have not received sufficient attention. These engineers look for process patterns within the application domain that can be exploited. Process patterns are ways of organizing inputs and outputs, performing transformations, and managing the information and control flow of the application. In designing transformations on data, they identify the essential algorithms within the application and seek to engineer them in the best possible way. Throughout this process, these engineers work to discover nonobvious ideas that are novel and useful. The following Intersection Script can be used to stimulate dialogue between systems engineers and software engineers:
1. What are the deep needs of the project? Are they being met? If not, what should be done?
2. Are there some customer desires that have not received attention? What are they?
3. Have operational usability considerations been overlooked? What are they?
4. Have any stakeholders been overlooked? If so, who are they?
5. What are the process patterns of the application domain? Are they being applied? If not, what should be done?
6. What are the essential algorithms of the solution? Are they being implemented in the best possible way? If not, what should be done?
7. Are there novel ideas that should be considered? If so, what should be done?
8. Are there other useful ideas that should be considered? What are they?
9. Are there some nonobvious ideas that should be considered? What are they?
   The Lab

The centerpiece of the Team Innovation Management (TIM) is the TIM Lab, the operational model for the intersection structured to accept teams of five systems engineers and five software engineers. Here systems engineers and software engineers are paired-up for their appearance in the intersection of innovation where the application domain and information technology clash and where each pair generates as many good ideas as possible presenting the results to the group which rank orders the most promising ideas. Participants engage each other in seeking out the deep needs in the application domain, identifying process transforming innovations, and pinpointing rules-based innovations. Participant pairs with the most promising ideas are invited to record their innovations in the form of Innovation Value Statements and to present these to an Enterprise Innovation Committee.

TIM Labs are held periodically. During the specification and design activities of the software life cycle, TIM Labs may be conducted monthly. During the maintenance and sustaining engineering activities, scheduling TIM Labs on a quarterly or semiannually basis may be best. Each systems engineer enters the intersection with each software engineer yielding a total of twenty-five intersection appearances. With five intersection appearances occurring concurrently and each appearance scheduled for 30 minutes, a TIM Lab for five systems engineers and five software engineers can be kicked off, conducted and wrapped up in a half day.

The Lab Results

As systems engineers and software engineers enter the intersection in pairs to discuss needs and capabilities, each pair generates as many innovative ideas as possible. These ideas are explicitly recorded on the Innovation Recording Form where they are categorized according to directional or intersectional, rules-based or process pattern, deep-seated need or nice-to-have capability, and producer or consumer innovation.

The Innovation Recording Form is prepared in the following format:

Innovation Recording Form

| | | | Rules- | | | | | |
|---|---|---|---|---|---|---|---|---|
| | | | based or | | | | Producer | |
| | Deep | Directional or | Process | | | | or | |
| Innovative | Need | Intersectional | Pattern | Novel | Useful | Nonobvious | Consumer | Description of the |
| Idea | (Y/N) | (D/I) | (R/P) | (Y/N) | (Y/N) | (Y/N) | (P/C) | Innovative Idea |
| 1 | | | | | | | | |
| 2 | | | | | | | | |
| 3 | | | | | | | | |
| 4 | | | | | | | | |

It may be useful to discuss the recording of one entry in detail. On Innovative Idea #1 the computation of true interest cost is quite important in the conduct of ecommerce online auctions of fixed income instruments. Sellers want to show the highest possible true interest cost to attract buyers. Controlling the finite word effects of underflow and the loss of low order bits achieves this. Therefore this idea addresses a deep need. It is directional because the idea is simply the application of good computer science practice. The implementation is rules-based in that it involves the method and rules of calculation and not the process. The idea originates with the producer. In the field of business and finance the idea is nonobvious and novel.

The outline for the Innovation Value Statement contains the following topics:
1. Background—discuss what matters most to the customer
2. Need for Change—discuss what is done in current practice and any measurements of critical aspects of current practice
3. Description—identify the most promising changes in current practice
4. Benefit—state the overall benefit expected to result from the change
5. Impact—assess any impact on the operation including side effects
6. Value to Customer—state the expected value to the customer
7. Value to Project—state the expected value to the project
8. Value to Organization—state the expected value to the organization
9. Actions to Implement—discuss a plan for lasting improvement, all implementation dimensions, and planning for transition into operation
   Smart Pipe of Innovation Management Tiers

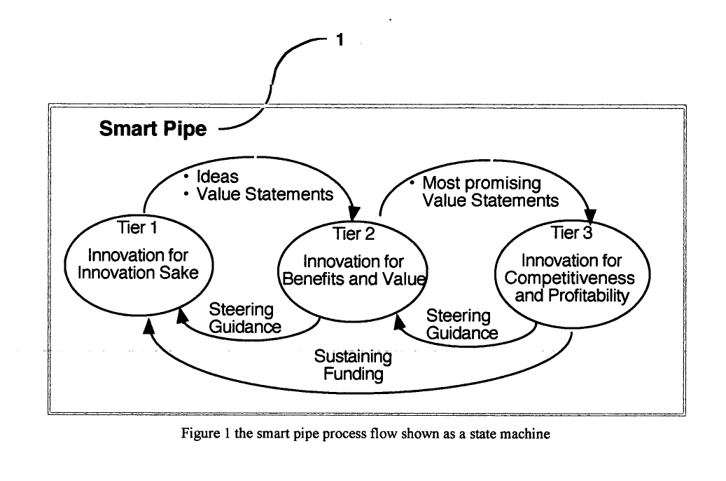

It is not enough to simply generate ideas. Ideas must systematically feed business and economic development. This involves harvesting ideas as intellectual property from knowledge workers on projects, selecting the most promising ideas and refining them into well framed statements of value, and impacting the business strategy and development with the best ideas. The smart pipe (1) process flow is shown as a state machine in FIG. 1.

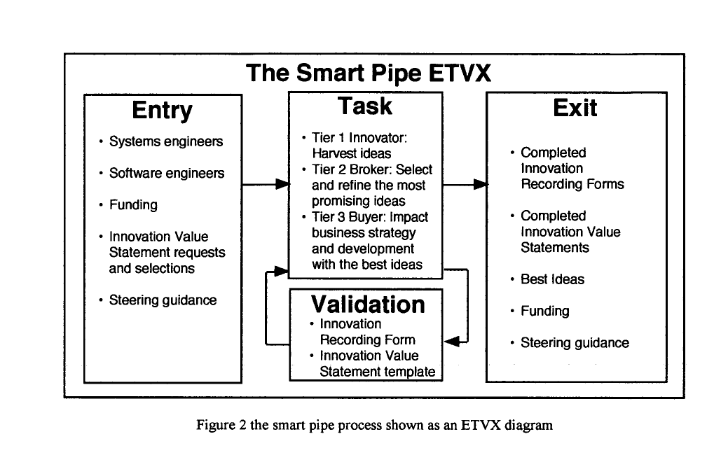

The smart pipe, tiered process will synthesize the interconnected layers or contexts formed by innovators who generate ideas, brokers who manage ideas and idea development, and buyers who use ideas for the benefit of the enterprise. The three tiers operate to identify innovative ideas and specify their value in multiple dimensions using an Innovation Value Statement, to judge and select the most promising value statements and to identify refinements intended to increase their benefit, and incorporate the best ideas in the business strategy and ongoing development in order to improve the competitiveness and profitability of the business and the value of the enterprise. The three tiers are synchronized through steering guidance from buyers to brokers and from brokers to innovators. FIG. 2 illustrates the smart pipe process shown as an ETVX diagram.

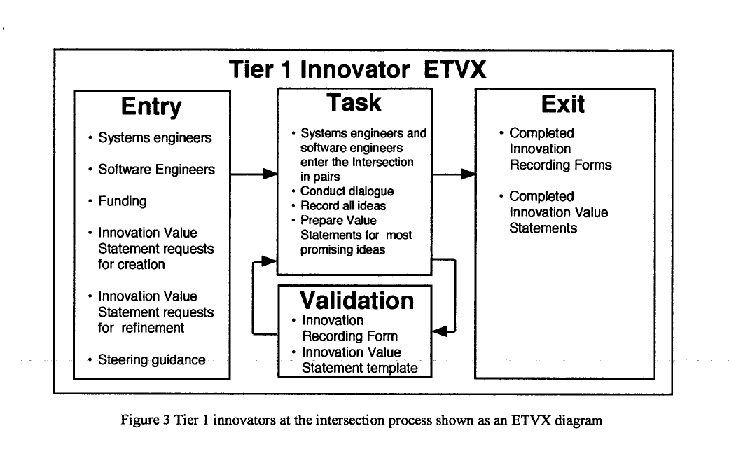

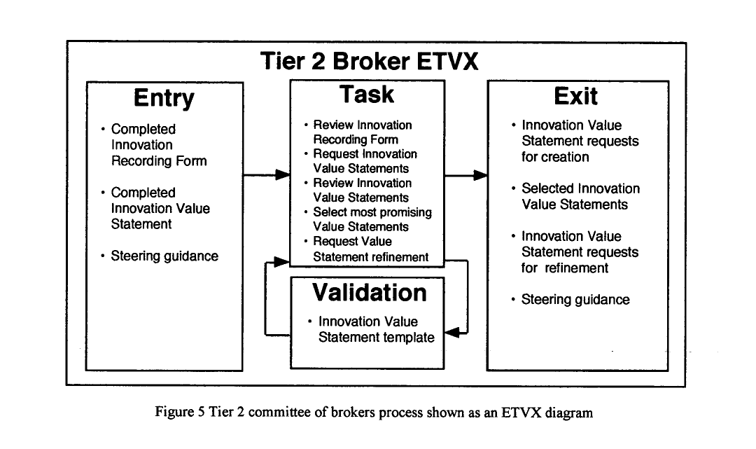

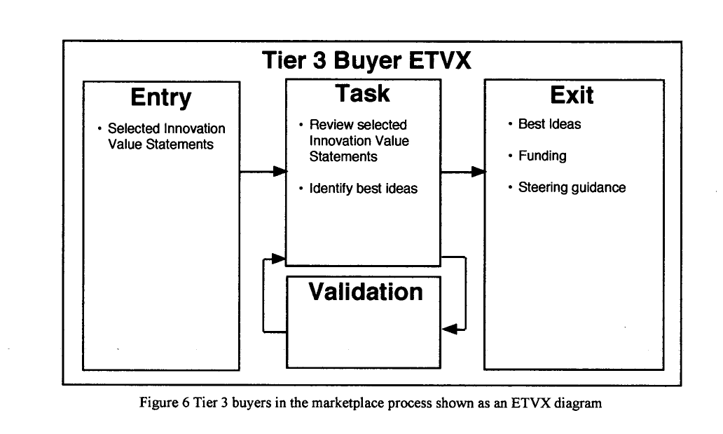

The three processes span onshore and offshore operations. The innovators at the intersection in tier 1 (shown in FIG. 3) include both global enterprise personnel and outsourced personnel who might perform the process all onshore, all offshore, or some onshore and some onshore. The committee of brokers in tier 2 (shown in FIG. 5) includes global enterprise personnel who are expected to perform the process onshore. The buyers in the marketplace in tier 3 (shown in FIG. 6) include global enterprise personnel who are expected to perform the process onshore.

New Insights and New Benefits

Looking forward . . . there will be new insights and new benefits. The persistent application of the TIM Lab will reveal valuable insights. These insights are enabled by Team Innovation Management (TIM) which is characterized by a short, intense, and repetitious exercise whose results are persistently retained. It features a mode of team collaboration among systems engineers and software engineers, the TIM Lab process, and the model of the intersection with its distinctions for directional and intersectional innovations that are rules-based or process patterned and producer or consumer sourced may reveal valuable insights with respect to achieving highly valued novel, useful, and nonobvious innovations.

The benefits of Team Innovation Management (TIM) include:
1. Improve systems and software engineering team capability to systematically collaborate in the cross discipline intersection between producers and consumers.
2. Improve enterprise compliance with the Organizational Innovation and Deployment process areas of the Capability Maturity Model Integration (CMMI) aimed at selecting and deploying improvements and institutionalizing the defined process associated with innovation and its management.
3. Improve the capability to guide producers and consumers towards intersectional, process transforming innovations that address deep needs.
4. Improve the capability to guide producers and consumers towards directional, rules-based innovations that improve efficiency and productivity.
5. Improve organizational readiness to deploy strategic offshore outsourcing.

### REFERENCES

1. “Software 2015: A National Software Strategy to Ensure U.S. Security and Competitiveness”, Report of the Second National Software Summit, Center for National Software Studies, 29 Apr. 2005, 24 pages http://www.CNsoftware.org
2. Porter, Michael E., “The Competitive Advantage of Nations”, The Free Press, New York 1998, 896 pages, ISBN 0684841479
3. “Innovate America”, National Innovation Initiative Report, 15 Dec. 2004, Council on Competitiveness, ISBN 1-889866-20-2, 68 pages
4. Florida, Richard L., “The Flight of the Creative Class: The New Global Competition for Talent”, Harper Collins, New York, 2005, 326 pages, ISBN 0-06-075690-X
5. Chrissis, Mary Beth, Mike Konrad, and Sandy Schrum, “CMMI: Guidelines for Process Integration and Product Improvement”, Addison-Wesley Professional, SEI Series in Software Engineering, 688 pages, ISBN 0321154967
6. Nicol, Michael R., “Policy Note to Readers”, CrossTalk, The Journal of Defense Software Engineering, Vol. 18 No 1, January 2005
7. M. Treacy and F. Wiersema, “The Discipline of Market Leaders: Choose Your Customers, Narrow Your Focus, Dominate Your Market”, Addison-Wesley, Reading, Mass., 1995
8. Johansson, Frans, “The Medici Effect: Breakthrough Insights at the Intersection of Ideas, Concepts, and Cultures”, Harvard Business School Press, 207 pages, September 2004
9. Levy, Frank and Richard J. Murnane, “The New Division of Labor: How Computers are Creating the Next Job Market” Princeton University Press, 174 pages, 2004, ISBN 0-691-11972-4

What is claimed is:

1. A method for managing and synthesizing innovation in the small on a software intensive systems project, the project including the steps of performing at least one activity selected from the following activities: specification, design, code, test, and maintenance of the software codes; said method involving tiered innovation management team processes including: harvesting ideas, selecting and refining the most promising ideas, and impacting business strategy and development;
Said method comprising the steps of:
a. systems engineers or software engineers as innovators harvesting ideas as intellectual property from other systems engineers or software engineers as knowledge workers as they interact in the multi-discipline intersection of innovation;
b. brokers of innovative ideas selecting the most promising ideas and guiding their refinement into well framed statements of value;
c. buyers of innovative ideas impacting business strategy and development with the best ideas.

2. The tier 1 process for innovators at the intersection as in claim 1 further comprising the additional steps of:
d. systems engineers and software engineers entering the multi-discipline intersection of innovation in pairs;
e. systems engineers and software engineers dialoging deep needs of the project, customer desires, operational usability, transformational process patterns, and rules-based computational algorithms;
f. systems engineers and software engineers recording and categorizing all ideas identified on the Innovation Recording Form;
g. systems engineers and software engineers preparing Innovation Value Statements for the most promising ideas;
h. systems engineers and software engineers receiving steering guidance from brokers.

3. The tier 2 process for brokers of innovative ideas as in claim 1 further comprising the additional steps of:
i. brokers reviewing Innovation Recording Forms;
j. brokers requesting additional Innovation Value Statements;
k. brokers reviewing Innovation Value Statements;
l. brokers selecting most promising Innovation Value Statements;
m. brokers requesting refinements to Innovation Value Statements;
n. brokers providing steering guidance to innovators;
o. brokers receiving steering guidance from buyers.

4. The tier 3 process for buyers of innovative ideas in the marketplace as in claim 1 further comprising the additional steps of:
p. buyers reviewing selected Innovation Value Statements;
q. buyers identifying best ideas;
r. buyers improving competitiveness and profitability of the business and the value of the enterprise;
s. buyers providing steering guidance to brokers.
